(19) United States
(12) Patent Application Publication
(10) Pub. No.: US 2003/0226984 A1
(43) Pub. Date: Dec. 11, 2003

(54) Method of and apparatus for reading out image and method of and apparatus for outputting correction information

(75) Inventor: Naoto Iwakiri, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/458,623

(22) Filed: Jun. 11, 2003

(30) Foreign Application Priority Data
Jun. 11, 2002 (JP) 170061/2002

(51) Int. Cl. G21K 4/00

(52) U.S. Cl. 250/580

(57) ABSTRACT

An image stored in a charge storing portion of a solid sensor as an electrostatic latent image upon exposure of the solid sensor to a recording electromagnetic wave is read out pixel by pixel through a reading electrode which defines the size of one pixel and an image signal is obtained. A defective image signal component obtained from a defective pixel whose sensitivity has changed out of the image signal components obtained from the respective pixels is detected, and the defective image signal component is corrected on the basis of a condition of correction on the basis of which a defective reference image signal component obtained from a defective pixel when reference image information is recorded on the defective pixel is corrected to be substantially equal to a normal reference image signal component obtained from a normal pixel when the reference image information is recorded on the normal pixel.

### BACKGROUND OF THE INVENTION

1. Field of the Invention

This invention relates to a method of and apparatus for reading image information recorded on a solid sensor as an electrostatic latent image to obtain an image signal and correcting the image signal. This invention further relates to a method of and an apparatus for outputting correction information for correcting an image signal readout from a solid sensor.

2. Description of the Related Art

There has been known a solid radiation sensor comprising a photoconductive layer such as of a selenium plate sensitive to a radiation such as X-rays. Upon exposure to the radiation carrying thereon radiation image information, each part of the solid radiation sensor stores an electric charge according to the amount of radiation to which the part is exposed, whereby a radiation image information carried by the radiation is recorded on the solid radiation sensor. The radiation image information can be read out from the solid radiation sensor by causing a recording light beam or a recording light line beam to scan the solid radiation sensor. See, for instance, U.S. Pat. Nos. 4,857,723 and 5,331,179. By the use of the solid radiation sensor, the irradiation dose to the patient can be reduced and at the same time, the diagnostic performance can be improved.

In Japanese Unexamined Patent Publication No. 2000-284056, a solid radiation sensor which enables high response in reading and efficient takeout of the signal charge to be compatible with each other. The solid radiation sensor comprises a first electrode layer permeable to recording radiation or light generated by excitation by the recording radiation, a recording photoconductive layer which exhibits conductivity upon exposure to the recording radiation or the light generated by excitation by the recording radiation, a charge storing portion which stores, as the latent image charge, an electric charge according to the amount of radiation to which the part is exposed, a reading photoconductive layer which exhibits conductivity upon exposure to reading electromagnetic wave and a second electrode layer permeable to the reading light which are superposed one on another in this order, and the second electrode layer comprises first and second stripe electrodes alternately arranged substantially in parallel to each other, the first stripe electrode formed by a plurality of linear electrodes permeable to the reading electromagnetic wave and the second stripe electrode formed by a plurality of linear electrodes impermeable to the reading electromagnetic wave.

In an image read-out apparatus employing the solid sensor described above, the second electrode layer comprising a number of linear electrodes is electrically connected to a signal obtaining system which reads out the image information recorded on the solid sensor and obtains an image signal through the second electrode layer.

A solid sensor in which TFTs (thin film transistors) are employed as the reading electrodes has been proposed. When thin film electrodes are employed as the reading electrodes, the planer electrode of each thin film transistor forms one pixel and a photoconductive layer on the thin film transistor transforms the electromagnetic wave to the electric charge, whereby the image information is obtained in the form of an electric signal. The planer electrodes are electrically connected to a signal obtaining system and the signal obtaining system reads out the image information recorded on the solid sensor through the planer electrodes to obtain an image signal.

In the case of a solid sensor where the size of one pixel is defined by one linear electrode, that is, each pixel is defined by a single linear electrode and a plurality of pixels are formed in the longitudinal direction of the linear electrode, one or more pixels are electrically insulated from the signal obtaining system when the linear electrode is broken and no image signal component (the image signal is made up of a plurality of image signal components each obtained from one pixel) is obtained from the one or more pixels. Similarly, when the signal line electrically connecting a planer electrode of a thin film transistor is broken, no image signal component is obtained from the pixel defined by the thin film transistor. The image signal component of such a defective pixel from which an image signal component cannot be electrically obtained is obtained by defect correction using an inter-pixel calculation or an inter-image calculation.

Whereas, in the case of a solid sensor where the size of one pixel is defined by a plurality of linear electrodes, that is, each pixel is defined by a plurality of linear electrodes and a plurality of pixels are formed in the longitudinal direction of the linear electrodes, even when one of the linear electrodes is broken and some of the pixels are not electrically connected to the signal obtaining system through the electrode, an image signal component can be obtained through the other linear electrodes.

That is, when image information carried by one pixel is read out through a plurality of linear electrodes, when one of the linear electrodes is broken, the part of the image information corresponding to the other linear electrodes can be read out through the other linear electrodes though the part of the image information corresponding to the broken linear electrode cannot be read out.

Also in the case where the image information is read out by the use of thin film transistors, an electrical defect can be caused in a part of one pixel, for instance, when the planer electrode of the thin film transistor is contaminated with impurities or a part of the reading photoconductive layer is contaminated with dust. So long as the electrical defect occupies only a part of the pixel, the image information can be read out from the other normal part of the pixel.

In either of the case where a linear electrode is employed and the case where a thin film transistor is employed, when an abnormal part exists in a part of one pixel, the image information can be read out only from the normal part of the pixel. That is, the pixel is deteriorated in sensitivity due to the abnormal part, which results in that a normal image signal cannot be obtained and an image reproduced is deteriorated in quality.

### SUMMARY OF THE INVENTION

In view of the foregoing observations and description, the primary object of the present invention is to correct a defective image signal component obtained from a defective pixel which is deteriorated in sensitivity due to an electrical defect.

In accordance with a first aspect of the present invention, there is provided a method of reading out an image, stored in a charge storing portion of a solid sensor as an electrostatic latent image upon exposure of the solid sensor to a recording electromagnetic wave, pixel by pixel through a reading electrode which defines the size of one pixel and obtaining an image signal, wherein the improvement comprises the steps of

detecting a defective image signal component obtained from a defective pixel whose sensitivity has changed due to electrical defect in a part of the pixel out of the image signal components obtained from the respective pixels of the solid sensor, and

correcting the detected defective image signal component on the basis of a condition of correction on the basis of which a defective reference image signal component obtained from a defective pixel when reference image information is recorded on the defective pixel is corrected to be substantially equal to a normal reference image signal component obtained from a normal pixel when the reference image information is recorded on the normal pixel.

In accordance with a second aspect of the present invention, there is provided an image read-out apparatus comprising a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, and an image read-out system which reads out the image information from the solid sensor pixel by pixel and outputs an image signal, wherein the improvement comprises

a storage system which storages a condition of correction on the basis of which a defective reference image signal component obtained from a defective pixel whose sensitivity has changed due to electrical defect in a part of the pixel when reference image information is recorded on the defective pixel is corrected to be substantially equal to a normal reference image signal component obtained from a normal pixel when the reference image information is recorded on the normal pixel and position information representing the position of the defective pixel, and

a signal correction system which detects a defective image signal component obtained from a defective pixel out of the image signal components obtained from the respective pixels of the solid sensor on the basis of the position information stored in the storage system, and corrects the detected defective image signal component on the basis of the condition of correction stored in the storage system.

In accordance with a third aspect of the present invention, there is provided a method of outputting correction information for correcting an image signal read out from a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, wherein the improvement comprises the steps of

detecting, on the basis of the signal value, a defective reference image signal component obtained from a defective pixel whose sensitivity has changed due to electrical defect in a part of the pixel out of the reference image signal components obtained from the respective pixels of the solid sensor when reference image information is recorded on the solid sensor,

detecting position information representing the position of the defective pixel from which the defective reference image signal component is obtained,

determining a condition of correction on the basis of which the defective reference image signal is corrected to be substantially equal to a normal reference image signal component obtained from a normal pixel when the reference image information is recorded on the solid sensor, and

outputting the detected position information and the determined condition of correction.

In accordance with a fourth aspect of the present invention, there is provided an apparatus for outputting correction information for correcting an image signal read out from a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, wherein the improvement comprises

a defect detecting system which detects, on the basis of the signal value, a defective reference image signal component obtained from a defective pixel whose sensitivity has changed due to electrical defect in a part of the pixel out of the reference image signal components obtained from the respective pixels of the solid sensor when reference image information is recorded on the solid sensor and position information representing the position of the defective pixel from which the defective reference image signal component is obtained,

a correcting condition setting system which sets a condition of correction on the basis of which the defective reference image signal is corrected to be substantially equal to a normal reference image signal component obtained from a normal pixel when the reference image information is recorded on the solid sensor, and

a correcting information outputting system which outputs the condition of correction set by the correcting condition setting system and the position information detected by the defect detecting system.

In this specification, the “image signal component” means a component of an image signal output from each of the pixels and the “image signal” is made up of image signal components output from all or almost all the pixels of the solid sensor.

The “recording electromagnetic wave” as used here means a radiation (including light) carrying thereon image information, which may be image information representing an object or reference image info for detecting defect.

The “reading electrode” is an electrode which defines the size of one pixel for reading image information and outputs the image information stored in the charge storing portion pixel by pixel. The reading electrode may comprise, for instance, a plurality of linear electrodes or thin film transistors.

The “reference image information” means image information which gives the same information over the entire area of the solid sensor, and may be, for instance, a solid image represented by a uniform radiation.

The “normal pixel” is a pixel which is free from electrical defect therein and outputs an image signal component substantially accurately reflecting the state of the electrostatic latent image stored in the corresponding portion of the charge storing portion of the solid sensor. Whereas, the “defective pixel” is a pixel which includes therein electrical defect and cannot output an image signal component substantially accurately reflecting the state of the electrostatic latent image stored in the corresponding portion of the charge storing portion of the solid sensor though can output a certain image signal component.

When reference image information is recorded on a solid sensor having both normal pixels and defective pixels, the reference image signal output from the solid sensor includes normal reference image signal components obtained from the normal pixels and defective reference image signal components obtained from the defective pixels.

Similarly, when image information representing an object is recorded on a solid sensor having both normal pixels and defective pixels, the image signal output from the solid sensor includes normal image signal components obtained from the normal pixels and defective image signal components obtained from the defective pixels.

The “electrical defect in a part of a pixel” means, for instance, that, in the case where the reading electrode comprises a plurality of linear electrodes and one pixel is defined by a plurality of linear electrodes, a part of the electrodes is electrically insulated.

In the case where the reading electrode comprises a plurality of thin film transistors and one pixel is defined by a planer electrode, the “electrical defect in a part of a pixel” means, for instance, that the planer electrode is contaminated with impurities or the planer electrode is different from the regular electrodes in area.

That is, a defective pixel has a part which cannot normally read out image information due to electrical defect in the reading electrode or due to impurities in the photoconductive layer on the linear electrode or the thin film transistor.

Further, when a pixel includes a part electrically insulated from the signal reading system or when a pixel, i.e., the linear electrodes or the planer electrode defining the pixel, is larger or smaller than the regular size, the pixel also can be a defective pixel.

The expression “the pixel's sensitivity has changed” means a state where the signal output from the pixel is different from a normal pixel in value.

In the present invention, the defective reference image signal component is detected by comparing the image signal components obtained from the respective pixels when the reference image information is recorded on the solid sensor with the normal reference image signal component obtained from a normal pixel and determining the reference image signal components which are different from the normal reference image signal component to be defective. The normal reference image signal component may be selected from image signal components obtained from pixels when the reference image information is read or may be prepared in advance by reading the reference image information through a known normal pixel.

The “condition of correction” may be any so long as the defective reference image signal component obtained from a defective pixel is corrected to be substantially equal to the normal reference image signal component, and may be, for instance, a gain by which the defective image signal component is multiplied or a constant to be added to the defective image signal component in offset correction. The condition of correction maybe set pixel by pixel or group by group. Further, the condition of correction may be common to all the defective pixels.

The “position information” represents the position of the defective pixel and may be, for instance, an address of the pixel set on the solid sensor.

The “condition of correction” to be stored in the storage means in the image read-out apparatus of the present invention may be either output from the image read-out apparatus or may be otherwise set or detected.

In accordance with the method of and apparatus for reading image information, since the defective image signal component obtained from a defective pixel is corrected on the basis of the condition of correction which is set according to the actual output of the pixel, the defective image signal component can be restored better than by correction using an inter-pixel calculation or an inter-image calculation, where the defective image signal component obtained from a defective pixel is corrected not on the basis of the actual output of the pixel, whereby deterioration of the image quality can be prevented.

In accordance with the method of and apparatus for outputting correction information of the present invention, since a defective reference image signal component obtained from a defective pixel is detected on the basis of the signal value out of the reference image signal components obtained from the respective pixels of the solid sensor when reference image information is recorded on the solid sensor and position information representing the position of the defective pixel from which the defective reference image signal component is obtained, the position of the defective pixel can be accurately detected and since the condition of correction is set on the basis of the defective reference image signal component, the condition of correction can be set accurately according to the actual sensitivity of the defective pixel.

### BRIEF DESCRIPTION OF THE DRAWINGS

FIG. 1 is a view schematically showing an apparatus for outputting correction information in accordance with a first embodiment of the present invention,

FIG. 2 is a fragmentary view showing in detail the solid sensor,

FIG. 3 is a plan view showing in detail the reading electrode layer,

FIG. 4 is a view showing defective pixels of the solid sensor,

FIG. 5 is a schematic view of a reference image reproduced through a solid sensor having defective pixels shown in FIG. 4,

FIG. 6 is a flow chart for illustrating output of the correction information by the apparatus for outputting correction information in accordance with the first embodiment of the present invention,

FIG. 7 is a view schematically showing an image read-out apparatus in accordance with a second embodiment of the present invention,

FIG. 8 is a flow chart for illustrating operation of the image read-out apparatus shown in FIG. 7,

FIG. 9 is a view schematically showing an image read-out apparatus in accordance with a third embodiment of the present invention,

FIG. 10 is a plan view showing a modification of the reading electrode layer, and

FIG. 11 is a perspective view showing another modification of the reading electrode layer.

### DESCRIPTION OF THE PREFERRED EMBODIMENTS

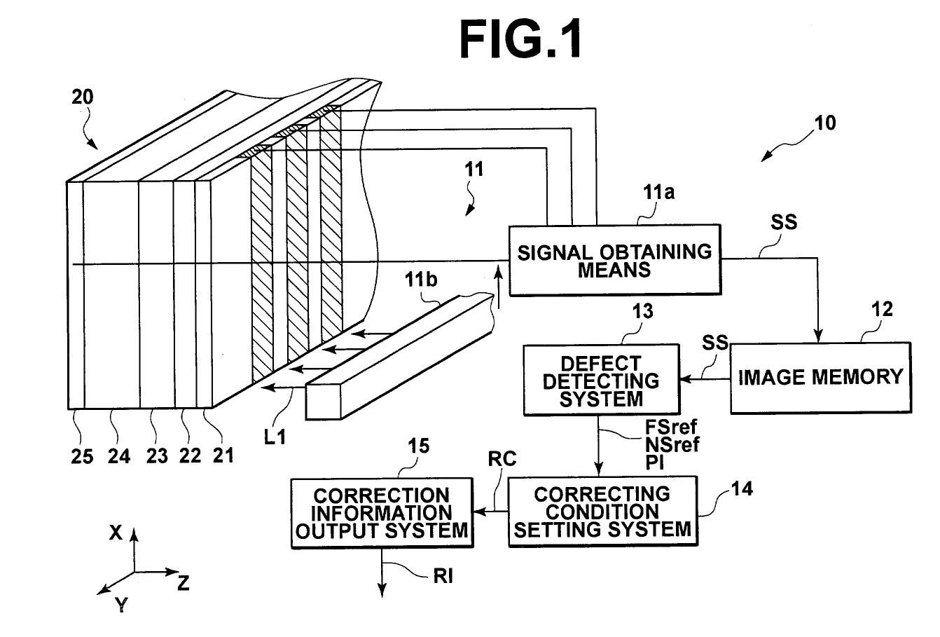

In FIG. 1, an apparatus 10 for outputting correction information in accordance with a first embodiment of the present invention is for outputting defective pixels in the solid sensor 20 and correction information R1 for each of the defective pixels, and comprises a signal read-out system 11, an image memory 12, a defect detecting system 13, a correcting condition setting system 14 and a correction information output system 15.

The signal read-out system 11 reads out reference image information recorded on a solid sensor 20 and outputs a reference image signal SS representing the reference image information. The signal read-out system 11 comprises a signal obtaining means 11a and a reading light projecting means 11b. The signal obtaining means 11a is electrically connected to a reading electrode layer 21 and a recording electrode layer 25 of the solid sensor 20. The signal obtaining means 11a detects a change of electric current between the reading electrode layer 21 and the recording electrode layer 25 to obtain reference image information recorded on the solid sensor 20 and outputs a reference image signal SS.

The reading light projecting means 11b projects reading light L1 in the form of a line beam onto the solid sensor 20 and causes the reading light L1 to scan the solid sensor in the X-direction. The signal obtaining means 11a receives reference image signal components from the pixels exposed to the reading light L1 and integrates the reference image signal components output from the pixels into the reference image signal SS.

The image memory 12 stores the reference image signal SS output from the signal obtaining means 11a.

The defect detecting system 13 detects normal reference image signal components NSref obtained from normal pixels, defective reference image signal components FSref obtained from defective pixels, and position information PI representing the positions of the defective reference image signal components FSref, and outputs them to the correcting condition setting system 14.

For example, the defect detecting system 13 generates a histogram representing the numbers of reference image signal components having respective signal values out of the reference image signal components making up the reference image signal SS stored in the image memory 12 and detects the signal value which the largest number of reference image signal components have as the signal value of the normal reference image signal component NRsef. Then the defect detecting system 13 compares the signal values of all the reference image signal components making up the reference image signal SS stored in the image memory 12 with the signal value of the normal reference image signal component NRsef and detects, as the defective reference image signal components FSref, those whose signal values are different from the signal value of the normal reference image signal component NRsef. The defect detecting system 13 detects position information PI representing the positions of the defective reference image signal components FSref and outputs the position information PI to the correcting condition setting system 14 together with the normal reference image signal components NSref and the defective reference image signal components FSref.

Even the signal value of a reference image signal component obtained from a normal pixel can slightly deviate from the signal value of the normal reference image signal component NSref, and accordingly, the reference image signal components whose signal values are different from the signal value of the normal reference image signal component NSref within a predetermined threshold value may be judged to be normal.

The defect detecting system 13 may be provided with a value of the normal reference image signal component NSref which has been set in advance by reading the reference image information through known normal pixels and may detect the defective reference image signal components FSref on the basis of the value of the normal reference image signal component NSref. The defect detecting system 13 detects, as the position information, the addresses of the defective reference image signal components FSref which have been inserted into the respective defective reference image signal components FSref by the signal obtaining means 11a.

The correcting condition setting system 14 sets a condition of correction RC on the basis of which the defective reference image signal component FSref is corrected to be substantially equal to the normal reference image signal component NSref on the basis of the values of the defective reference image signal component FSref and the normal reference image signal component NSref output from the defect detecting system 13. For example, in the case where the condition of correction RC is on the gain, the correcting condition setting system 14 calculates a value of a gain by which the defective reference image signal component FSref is to be multiplied to cause the defective reference image signal component FSref to be substantially equal to the normal reference image signal component NSref. Then the correcting condition setting system 14 outputs the calculated gain to the correction information output system 15 as the condition of correction RC. The correcting condition setting system 14 may be provided with a value of the normal reference image signal component NSref which has been set in advance by reading the reference image information through known normal pixels and may set the condition of correction RC by the use of the value of the normal reference image signal component NSref.

Since the defective pixels are continuous in the direction in which the linear electrodes extend (the sub-scanning direction=the X-direction), the correcting condition setting system 14 may set the same condition of correction RC for a plurality of continuous defective pixels.

Further, the correcting condition setting system 14 may calculates offsets and gains by the use of a plurality of pieces of reference image information different in density and may set the condition of correction RC on the basis of the offsets and the gains.

The correction information output system 15 outputs correction information RI comprising the condition of correction RC output from the correcting condition setting system 14 linked with the position information PI output from the defect detecting system 13. This arrangement is advantageous in that the condition of correction RC can be set different according to the degree of change of sensitivity and the accuracy of correction is improved.

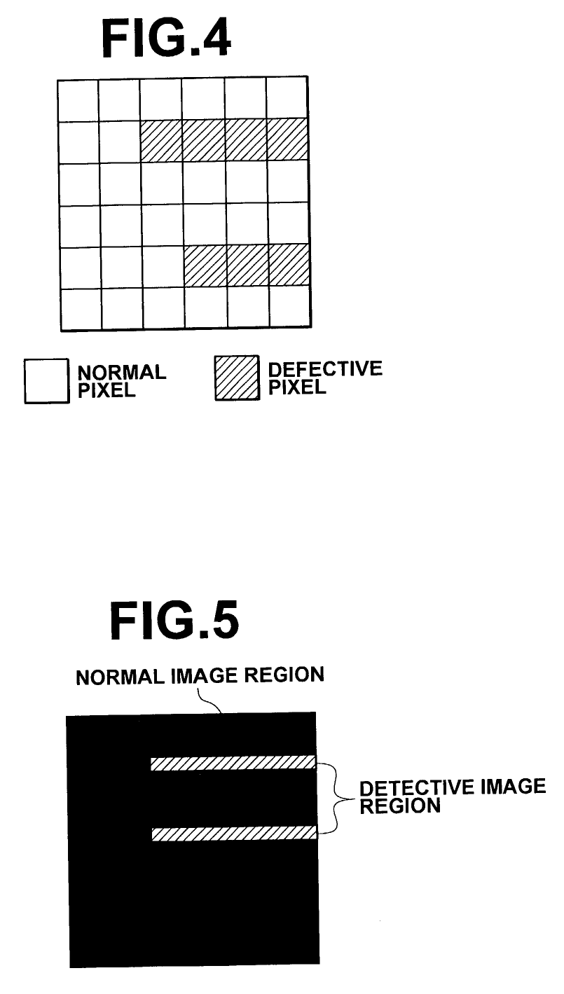

It is possible to arrange the correction information output system 15 to group the pieces of position information on the defective pixels by the conditions of correction RC and outputs the pieces of correction information in the groups. This is advantageous in that, in the case where the reading electrode layer 21 comprises a plurality of linear electrodes as will be described later, the defective pixels are arranged in lines as shown in FIGS. 4 and 5 and the conditions of correction RC are set line by line, whereby it becomes unnecessary to include the same condition of correction in the pieces of correction information RI, which results in a small volume of the correction information RI makes it feasible for an image read-out apparatus 30 to be described later to perform the correction efficiently.

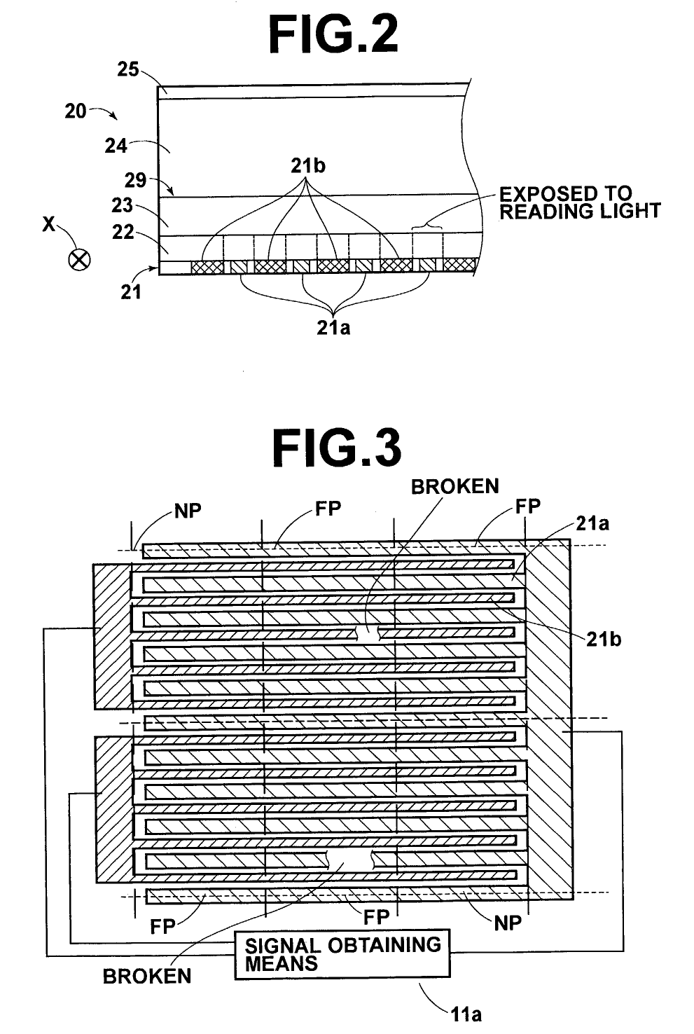

FIG. 2 shows in detail the solid sensor 20, and FIG. 3 is a plan view showing in detail the reading electrode layer 21.

As shown in FIGS. 2 and 3, the solid sensor 20 comprises reading electrode layer 21, a reading photoconductive layer 22, a charge transfer layer 23, a recording photoconductive layer 24 and a recording electrode layer 25. The reading electrode layer 21 comprises a plurality of first and second linear electrodes 21a and 21b which are alternately arranged in the scanning direction (X-direction) substantially in parallel to each other. The first linear electrodes 21a are electrically insulated from the second linear electrodes 21b.

The first linear electrodes 21a are of a light-transmissible conductive layer formed of, for instance, nesa film or ITO film, and the second linear electrodes 21b are of a light-shielding conductive layer coated with metal such as Al, Cr or the like.

Each pixel is defined by a predetermined number of first linear electrodes 21a and a predetermined number of second linear electrodes 21b. That is, in the example shown in FIG. 3, four first linear electrodes 21a and five second linear electrodes 21b adjacent two of which are disposed on opposite sides of one of the first linear electrodes 21a define a row of pixels which are arranged in the longitudinal direction of the linear electrodes 21a and 21b. The first linear electrodes 21a defining the same row of pixels are electrically connected with each other and the second linear electrodes 21b defining the same row of pixels are electrically connected with each other.

The image information (the image signal component) is output from the pixels exposed to the reading light L1 by way of the first linear electrodes 21a. The pixel from which the image signal component is output is switched in the Y-direction, for instance, by a switching action by the signal obtaining means 11a.

The reading photoconductive layer 22 on the reading electrode layer 21 exhibits conductivity upon exposure to the reading light L1 and generates charged pairs. Since the first linear electrodes 21a transmit light and the second linear electrodes 21b do not transmit light, charged pairs are generated by the reading photoconductive layer 22 in the regions corresponding to the first linear electrodes 21a when the reading light L1 is projected onto the solid sensor 20 from the reading electrode layer side.

The charge transfer layer 23 on the reading photoconductive layer 22 behaves like a substantially insulating material, for instance, to a negative charge and behaves like a substantially conductive material to a positive charge.

The recording photoconductive layer 24 on the charge transfer layer 23 exhibits conductivity upon exposure to the recording electromagnetic wave (light or radiation) and generates charged pairs. A charge storing portion 29 is formed on an interface of the charge transfer layer 23 and the recording photoconductive layer 24. When electrons generated in the recording photoconductive layer 24 attempt to move toward the reading electrode layer 21 under the force of an electric field established between the reading electrode layer 21 and the recording electrode layer 25, the charge transfer layer 23 suppresses the movement of the electrons. Accordingly, electric charges proportional to the amount of recording electromagnetic wave projected onto the solid sensor 20 are stored in the charge storing portion 29 as an electrostatic latent image.

The recording electrode layer 25 is formed, for instance, of ITO film and is permeable to the recording electromagnetic wave. The recording electrode layer 25 is electrically connected to the signal obtaining means 11a.

An example of operation of the solid sensor 20 will be described with reference to FIGS. 1 and 2, hereinbelow.

A high voltage is first applied across the reading electrode layer 21 and the recording electrode layer 25 by the signal obtaining means 11a so that the reading electrode layer 21 is positively charged and the recording electrode layer 25 is negatively charged. When the recording electromagnetic wave is subsequently projected onto the solid sensor 20 from the recording electrode side, charged pairs are generated in the recording photoconductive layer 24 in proportion to the amount of recording electromagnetic wave. The positive holes of the charged pairs move to the recording electrode 25 and combine with negative charges on the recording electrode 25 to cancel each other. The electrons of the charged pairs attempt to move to the reading electrode layer 21, the charge transfer layer 23 suppresses the movement of the electrons. Accordingly, electric charges proportional to the amount of recording electromagnetic wave projected onto the solid sensor 20 are stored in the charge storing portion 29 as an electrostatic latent image.

Reading out the electrostatic latent image (image information) recorded in the charge storing portion 29 will be described, hereinbelow.

The first linear electrodes 21a and the second linear electrodes 21b of the reading electrode layer 21 are electrically connected to have the same electric potential. In this state, when the reading light L1 is projected onto the solid sensor 20 from the reading electrode layer side with the reading light L1 caused to scan the substantially entire area of the reading electrode layer 21, charged pairs are generated in the reading photoconductive layer 22. The positive holes of the charged pairs move through the charge transfer layer 23 to the charge storing portion 29 and combine with negative charges stored in the charge storing portion 29 to cancel each other. Whereas, the electrons of the charged pairs move to the first linear electrodes 21a of the reading electrode 21 and combine with positive charges on the first linear electrodes 21a.

When the electrons of the charged pairs move to the first linear electrodes 21a of the reading electrode 21 and combine with positive charges on the first linear electrodes 21a, the electrons and the positive holes combine with each other from the vicinity of the center of the first linear electrode 21a. Similarly, when the positive holes of the charged pairs generated in the reading photoconductive layer 22 combine with electrons in the charge storing portion 29, the electrons and the positive holes combine with each other from the portion corresponding to the vicinity of the center of the first linear electrode 21a. As the electrons of the charged pairs combine with positive charges on the first linear electrodes 21a, the positive charges on the second linear electrodes 21b connected to the first linear electrodes 21a move to the first linear electrodes 21a.

Negative charges for each pixel stored in the charge storing portion 29 are moved toward the region where they combined with the positive holes generated in the reading photoconductive layer 22, i.e., toward the first linear electrodes 21a as reading progresses. By progressively moving the negative charges stored in the charge storing portion 29 toward the first linear electrodes 21a, high response in reading and efficient takeout of the signal charge can be obtained at one time. An electric current flows to the signal obtaining means 11a when positive holes and electrons are combined on the first linear electrodes 21a. By detecting change of the electric current, an image signal is obtained.

As described above, one pixel is defined by four first linear electrodes 21a and five second linear electrodes 21b adjacent two of which are disposed on opposite sides of one of the first linear electrodes 21a as shown in FIG. 3. For example, when one first linear electrode 21a is broken so that the first linear electrode 21a is divided into a part electrically connected to the image obtaining means 11a and an insulated part (a part electrically insulated from the image obtaining means 11a), the insulated part of the first linear electrode 21a cannot be positively charged when a high voltage is applied across the reading electrode layer 21 and the recording electrode layer 25 by the signal obtaining means 11a upon recording and, accordingly, no electric field to move toward the reading electrode layer 21 the electrons generated in the recording photoconductive layer 24 upon exposure to the recording electromagnetic wave is established in the region opposed to the insulated part of the first linear electrode 21a. A pixel including a broken part of the first linear electrode 21a cannot represent a part of the image information and forms a defective pixel.

Even a pixel which does not include a broken part can be a defective pixel when at least one of the first linear electrodes 21a defining the pixel is electrically insulated from the signal obtaining means 11a by a broken part in an upstream pixel.

When one of the four first linear electrodes 21a defining a pixel is insulated from the signal obtaining means 11a, the signal value of the defective reference image signal component FSref obtained from the defective pixel is substantially ¾ of the signal value of the normal reference image signal component NSref. When two of the four first linear electrodes 21a defining a pixel are insulated from the signal obtaining means 11a, the signal value of the defective reference image signal component FSref obtained from the defective pixel is substantially ½ of the signal value of the normal reference image signal component NSref. Further, when three of the four first linear electrodes 21a defining a pixel are insulated from the signal obtaining means 11a, the signal value of the defective reference image signal component FSref obtained from the defective pixel is substantially ¼ of the signal value of the normal reference image signal component NSref.

Even when one second linear electrode 21b is broken so that the second linear electrode 21b is divided into a part electrically connected to the image obtaining means 11a and an insulated part (a part electrically insulated from the image obtaining means 11a), the part of the first linear electrode 21a opposed to the insulated part of the second linear electrode 21b can output an image signal component. However, since an image signal component is read on the basis of the positive charges stored on the first linear electrode 21a and the second linear electrodes 21b on opposite sides of the first linear electrode 21a, the positive charges are reduced and the signal value obtained from a pixel is reduced when the pixel includes a second linear electrode 21b insulated from the signal obtaining means 11a. A pixel including a second linear electrode 21b insulated from the signal obtaining means 11a also forms a defective pixel.

Further, impurities such as dirt or dust included in the first linear electrode 21a can disable the pixel from obtaining electric charges. Accordingly, a pixel including impurities such as dirt or dust can form a defective pixel.

Further, impurities such as dirt or dust included in the reading photoconductive layer 22, the charge transfer layer 23 and/or the recording photoconductive layer 25 can prevent movement of the electric charges, thereby preventing accurate recording or reading of image information. Accordingly, a pixel opposed to the reading photoconductive layer 22, the charge transfer layer 23 or the recording photoconductive layer 25 including impurities such as dirt or dust can form a defective pixel.

In the solid sensor 20 where each pixel is defined by a plurality of first linear electrodes 21a and a plurality of second linear electrodes 21b, the image signal component obtained from a defective pixel is smaller in the amount of charges than that obtained from a normal pixel.

Since when a part of the first or second linear electrode 21a or 21b is broken, a pixel including the broken part and pixels downstream of the broken part as seen from the signal obtaining means 11a become defective. Accordingly, defective pixels tend to be continuous in the direction of scanning as shown in FIG. 4. When a black solid image is recorded on and read from a solid sensor 20 including such defective pixels, an image having a linear thin part is reproduced as shown in FIG. 5. In the image shown in FIG. 5, the density is increased as the signal value increases.

The apparatus 10 for outputting correction information detects the defective pixels and sets a condition of correction RC on the basis of which the defective reference image signal component FSref is corrected to be substantially equal to the normal reference image signal component NSref, whereby deterioration of an image signal obtained from the solid sensor 20 can prevented.

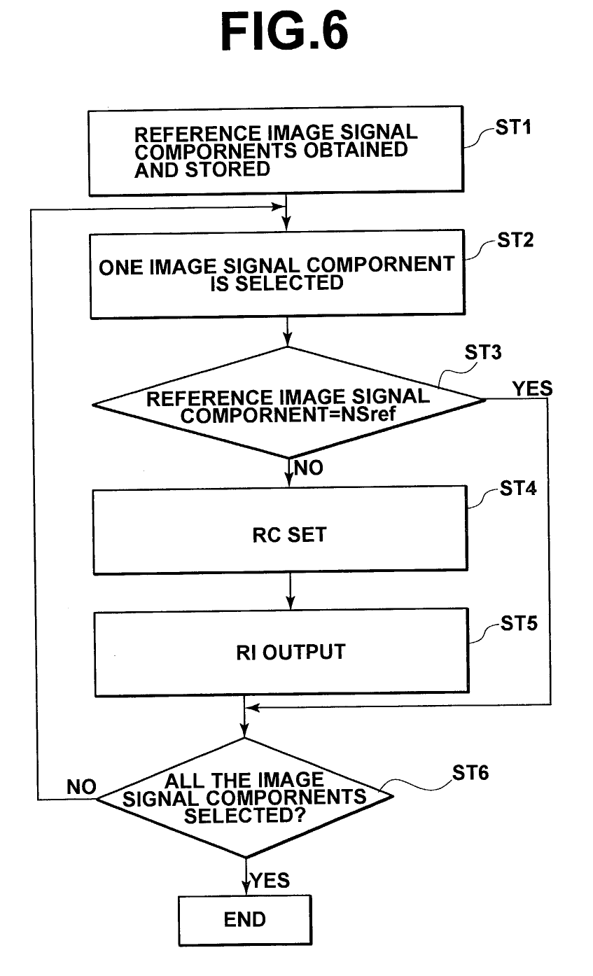

FIG. 6 is a flow chart for illustrating output of the correction information. Output of the correction information in this embodiment will be described with reference to FIGS. 1 to 6, hereinbelow. When the correction information is to be output, a reference image information representing, for instance, a black solid image, is recorded on the solid sensor 20.

In this state, reference image signal components are read from the respective pixels of the solid sensor 20 by way of the reading electrode layer 21 and stored in the image memory 12. (stepST1) Since the reference image information has been recorded on the solid sensor 20, a reference image signal SS is stored in the image memory 12. Then one image signal component is selected from the image signal components making up the reference image signal SS stored in the image memory 12. (step ST2)

Then the defect detecting system 13 compares the selected image signal component with the normal reference image signal component NSref. (step ST3) When the former is substantially equal to the latter, the defect detecting system 13 determines the image signal component to be obtained from a normal pixel.

Whereas when the former is not substantially equal to the latter, the defect detecting system 13 determines the image signal component to be a defective image signal component FSref. Then the defect detecting system 13 outputs the detected defective reference image signal component FSref and the normal reference image signal component NSref together with the position information PI representing the position of the defective reference image signal component FSref to the correcting condition setting system 14.

The correcting condition setting system 14 sets a condition of correction RC on the basis of the values of the defective reference image signal component FSref and the normal reference image signal component NSref output from the defect detecting system 13. (step ST4) For example, in the case where the condition of correction RC is on the gain, the correcting condition setting system 14 calculates a value of a gain by which the defective reference image signal component FSref is to be multiplied to cause the defective reference image signal component FSref to be substantially equal to the normal reference image signal component NSref. Then the correcting condition setting system 14 outputs the condition of correction RC set to the correction information output system 15. The correction information output system 15 outputs correction information RI comprising the condition of correction RC output from the correcting condition setting system 14 linked with the position information PI output from the defect detecting system 13. (step ST5)

The steps ST1 to ST5 are repeated for all the pixels of the solid sensor 20 and the condition of correction RC is set for all the defective pixels. (step ST6)

By the use of the correction information RI where the condition of correction RC is linked with the position information PI, the image signal can be corrected, for instance, in an image read-out apparatus to be described later, whereby deterioration in image quality due to defective pixels can be suppressed. Especially, in this embodiment, since the defective pixels are detected on the basis of the reference image signal components obtained by actually reading reference image information, the position information representing the positions of the defective pixels can be accurately obtained.

Further, since the condition of correction RC can be set according to the actual condition of each defective pixel, deterioration in image quality due to defective pixels can be better suppressed. The actual condition differs defective pixel to defective pixel. For example, in one defective pixel, one first linear electrode 21a is only broken, in another defective pixel, one first linear electrode 21a and one second linear electrode 21b are broken, and in still another defective pixel, three first linear electrodes 21a are broken. In the embodiment described above, the condition of correction RC can be set for each defective pixel, whereby deterioration in image quality due to defective pixels can be better suppressed.

Further, unlike the conventional inter-pixel calculation or inter-image calculation, since the condition of correction RC is set on the basis of the defective reference image signal actually obtained from the defective pixel, a real image signal component to be obtained through the pixel can be faithfully restored.

In the case where the reading electrode layer 21 comprises a plurality of first linear electrodes 21a and a plurality of second linear electrodes 21b as shown in FIG. 3, a breakage in one linear electrode appears as line deterioration in image as shown in FIG. 5 and deterioration in image is more serious than in the case where the reading electrode layer 21 comprises a plurality of thin film transistors. By setting the condition of correction RC pixel by pixel as described above, deterioration of image quality can be prevented in the following image read-out apparatus where the solid sensor 20 includes defective pixels.

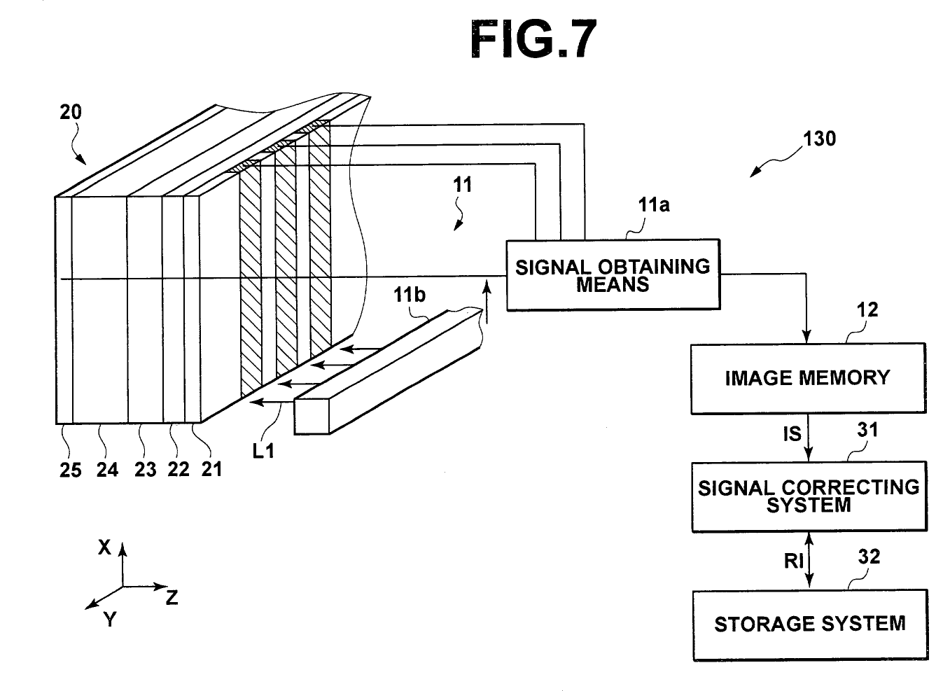

FIG. 7 shows an image read-out apparatus 30 in accordance with a second embodiment of the present invention.

The image read-out apparatus 30 of this embodiment comprises a signal read-out system 11, an image memory 12, a solid sensor 20, a signal correcting system 31 and a storage system 32. The signal read-out system 11, the image memory 12 and the solid sensor 20 are the same as those shown in FIG. 1, and accordingly are given the same reference numerals and will not be described here. The signal read-out system 11 and the solid sensor 20 may be either removable or unremovable.

The signal correcting system 31 detects defective image signal components from the image signal IS stored in the image memory 12 and corrects the defective image signal components on the basis of the condition of correction RC. That is, the signal correcting system 31 is electrically connected to the storage system 32 and can access to the storage system 32 which stores the condition of correction RC linked with the position information PI, which have generated, for instance, by the apparatus 10 for outputting correction information. The signal correcting system 31 detects the defective image signal components on the basis of the position information PI and corrects the detected defective image signal components by the condition of correction RC. For example, when the condition of correction RC is related to the gain, the signal correcting system 31 multiplies the defective image signal component by the value of the gain designated by the condition of correction RC, and then the signal correcting system 31 overwrites the defective image signal components with the corrected defective image signal components.

In this manner, the defective image signal components can be corrected to a value which would be if the pixels from which they are obtained are normal, whereby deterioration in image quality due to defective image signal components can be prevented. Further, the percentage of rejects of the solid sensor 20 can be reduced or the yield of the solid sensor 20 is improved since an image of high quality can be read out even from a solid sensor 20 having one or more broken linear electrode.

Further, when the condition of correction RC is related to the gain, not only particular one or more of the properties represented by the image information but also all the properties represented by the image information such as the contrast, sharpness, grainness and the like can be corrected.

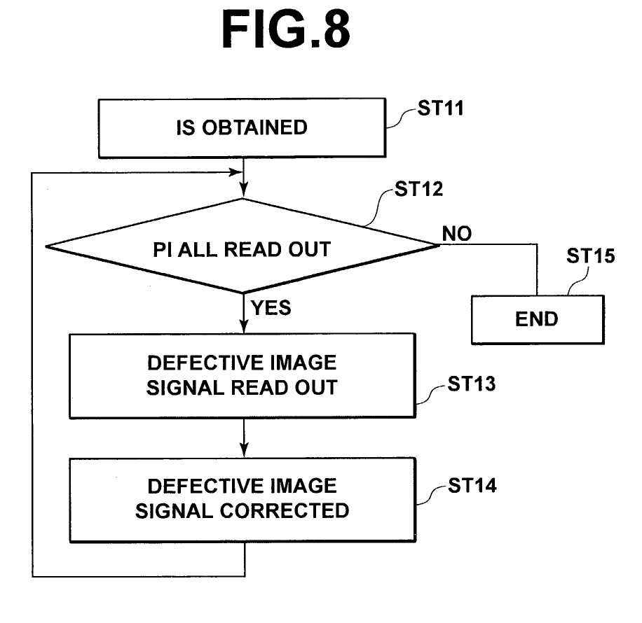

FIG. 8 is a flow chart for illustrating operation of the image read-out apparatus 30 of this embodiment. Operation of the image read-out apparatus 30 of this embodiment will be described with reference to FIGS. 7 and 8, hereinbelow.

In a state where an electrostatic latent image representing image information has been stored in the charge storing portion 29 of the solid sensor 20, an image signal IS representing the electrostatic latent image is taken out from the solid sensor 20 by the signal obtaining means 11a. The image signal IS is stored in the image memory 12. (step ST11)

Then pieces of position information PI representing defective image signal components which have not been corrected are read out one by one from the storage system 32. (step ST12) When all the pixels of the solid sensor 20 are normal or all the pieces of image information PI have been read out from the storage system 32, processing is ended. (step ST15)

When a piece of position information PI is detected, the signal correcting system 31 obtains a defective image signal component from the image memory 12 on the basis of the position information PI. (step ST13)

Then the signal correcting system 31 corrects the defective image signal component according to the condition of correction RC. For example, when the condition of correction RC is related to the gain, the signal correcting system 31 multiplies the defective image signal component by the value of the gain designated by the condition of correction RC, and then the signal correcting system 31 overwrites the defective image signal components with the corrected defective image signal components. (step ST14)

The steps ST12 to ST14 are repeated until all the pieces of position information PI stored in the storage system 32 are read out.

By correcting the defective image signal components obtained from the defective pixels by the use of the condition of correction RC set by the apparatus 10 for outputting correction information and the position information PI, deterioration in image quality due to the defective pixels can be suppressed. Further, since the condition of correction RC is set on the basis of the defective reference image signal actually obtained from the defective pixel, a real image signal component to be obtained through the pixel can be faithfully restored. Further, since the condition of correction RC can be set according to the actual condition of each defective pixel, deterioration in image quality due to defective pixels can be surely suppressed.

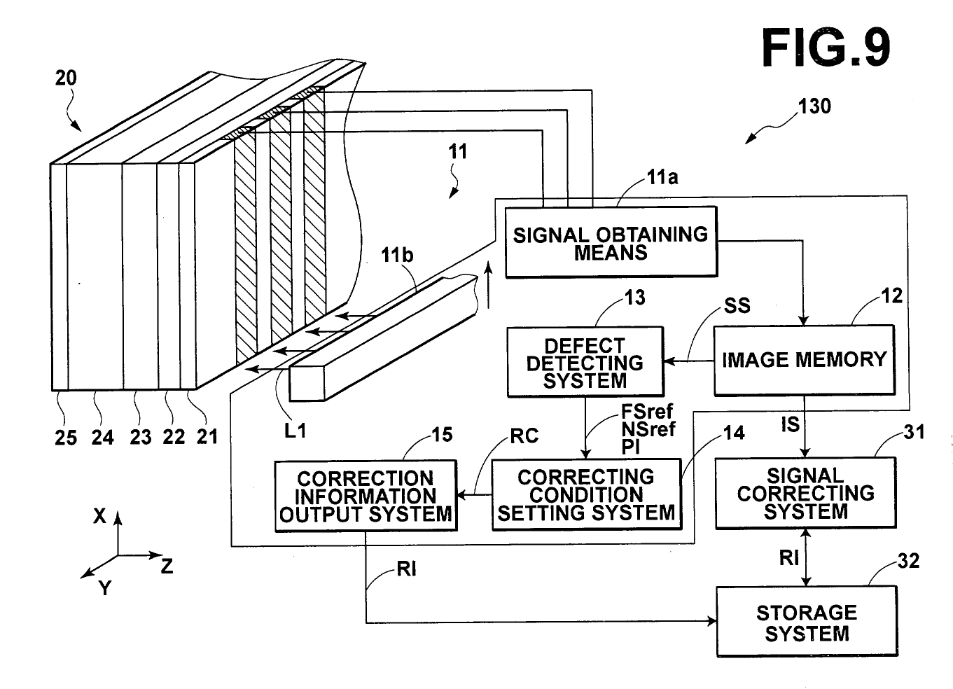

FIG. 9 is a view schematically showing an image read-out apparatus in accordance with a third embodiment of the present invention. In FIG. 9, the elements analogous to those in the image read-out apparatus 30 shown in FIG. 7 are given the same reference numerals and will not be described here.

The image read-out apparatus 130 of this embodiment is provided therein with the apparatus 10 for outputting correction information in accordance with the first embodiment of the present invention and has a function of self-diagnosis for detecting the defective pixels. That is, the image read-out apparatus 130 of this embodiment is periodically switched to a test mode where the solid sensor 20 is examined. With this arrangement, the actual state of each pixel can be surely detected and the defective image signal components can be surely corrected even if the state of the defective pixels changes with time or defective pixels are newly generated.

The present invention can be variously embodied without limited to the illustrated embodiments.

For example, though, in the image read-out apparatus 30, the defective image signal components are corrected on the basis of the correction information RI output from the apparatus 10 for outputting correction information, other correction information may be stored in the storage section 32 and may be employed to correct the defective image signal components. For example, defective pixels may be detected by causing an electric current to flow through the first and second linear electrodes 21a and 21b and detecting the amount of current flowing through each of the first and second linear electrodes 21a and 21b, and the same condition of correction RC may be set uniformly for the defective image signal components obtained from the detected defective pixels.

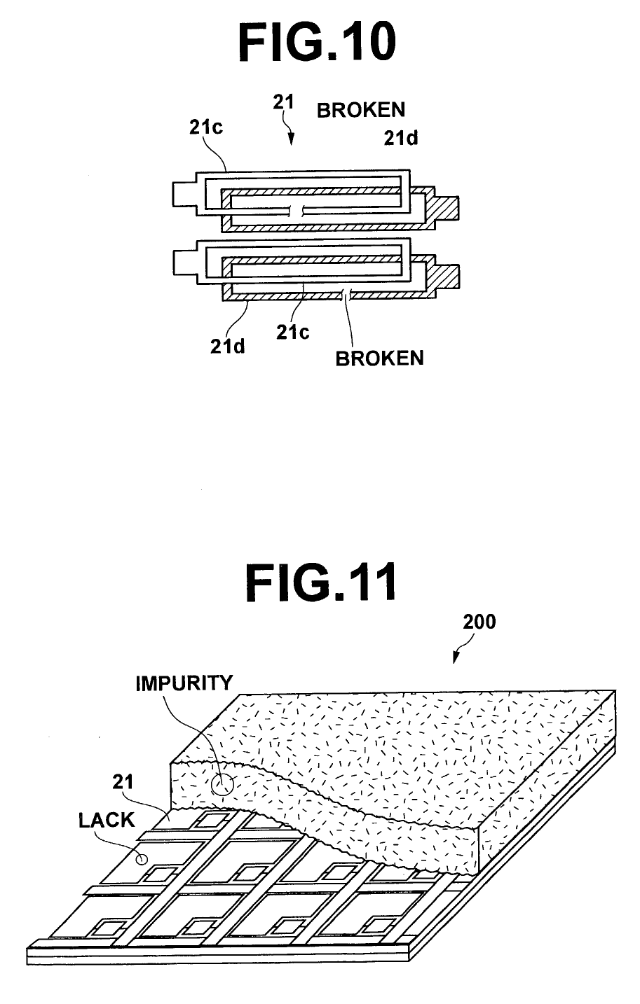

Though, in the embodiments described above, the reading electrode layer 21 comprises a plurality of first and second linear electrodes 21a and 21b, the reading electrode layer 21 may comprise a plurality of first and second loop electrodes 21c and 21d as shown in FIG. 10. In the case of a loop electrode, even if a loop electrode is broken at a part, an image signal component can be taken out from the electrode since the electrode is not electrically insulated. However, since the electrode comes to differ from normal electrodes in the effective length, the broken electrode generates a defective image signal component representing a density different from the normal image signal component generated from normal pixels. Also, in this case, the present invention may be applied to correct the defective image signal components obtained from the broken loop electrodes.

Further, though, in the embodiments described above, the first and second linear electrodes 21a and 21b are flush with each other, an insulator may be interposed between the first and second linear electrodes 21a and 21b.

Further, the present invention may be applied to a solid sensor 200 where the reading electrode layer 21 comprises a plurality of planer electrodes of thin film transistors as shown in FIG. 11. That is, in this solid sensor 200, each pixel is defined by a substantially square planer electrode. In this case, an image signal component can be taken out from the electrode even when there is an electrically defective part due to an impurity or lack of material. However, the image signal component obtained from the defective pixel is smaller in the amount of signal than image signal components obtained from normal pixels. Also in this case, deterioration of image quality can be prevented by correcting the image signal components obtained from the defective pixels.

Though, in the embodiments described above, the defective image signal components are corrected by correcting the gain, the condition of correction RC may be set on the offset. Further, though, in the embodiments described above, the condition of correction RC is set defective pixel by defective pixel, the condition of correction may be set group by group according to the state of the defect of the defective pixels.

What is claimed is:

1. A method of reading out an image, stored in a charge storing portion of a solid sensor as an electrostatic latent image upon exposure of the solid sensor to a recording electromagnetic wave, pixel by pixel through a reading electrode which defines the size of one pixel and obtaining an image signal, wherein the improvement comprises the steps of
detecting a defective image signal component obtained from a defective pixel whose sensitivity has changed due to electrical defect in a part of the pixel out of the image signal components obtained from the respective pixels of the solid sensor, and
correcting the detected defective image signal component on the basis of a condition of correction on the basis of which a defective reference image signal component obtained from a defective pixel when reference image information is recorded on the defective pixel is corrected to be substantially equal to a normal reference image signal component obtained from a normal pixel when the reference image information is recorded on the normal pixel.

2. An image read-out apparatus comprising a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, and an image read-out system which reads out the image information from the solid sensor pixel by pixel and outputs an image signal, wherein the improvement comprises
a storage system which storages a condition of correction on the basis of which a defective reference image signal component obtained from a defective pixel whose sensitivity has changed due to electrical defect in a part of the pixel when reference image information is recorded on the defective pixel is corrected to be substantially equal to a normal reference image signal component obtained from a normal pixel when the reference image information is recorded on the normal pixel and position information representing the position of the defective pixel, and
a signal correction system which detects a defective image signal component obtained from a defective pixel out of the image signal components obtained from the respective pixels of the solid sensor on the basis of the position information stored in the storage system, and corrects the detected defective image signal component on the basis of the condition of correction stored in the storage system.

3. A method of outputting correction information for correcting an image signal read out from a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, wherein the improvement comprises the steps of
detecting, on the basis of the signal value, a defective reference image signal component obtained from a defective pixel whose sensitivity has changed due to electrical defect in a part of the pixel out of the reference image signal components obtained from the respective pixels of the solid sensor when reference image information is recorded on the solid sensor,
detecting position information representing the position of the defective pixel from which the defective reference image signal component is obtained,
determining a condition of correction on the basis of which the defective reference image signal is corrected to be substantially equal to a normal reference image signal component obtained from a normal pixel when the reference image information is recorded on the solid sensor, and
outputting the detected position information and the determined condition of correction.

4. An apparatus for outputting correction information for correcting an image signal read out from a solid sensor having a charge storing portion which, upon exposure of the solid sensor to a recording electromagnetic wave, stores electric charges as an electrostatic latent image according to the amount of electromagnetic wave to which it is exposed, and a reading electrode which outputs the image information stored in the charge storing portion while defining the size of one pixel for reading image information, wherein the improvement comprises
a defect detecting system which detects, on the basis of the signal value, a defective reference image signal component obtained from a defective pixel whose sensitivity has changed due to electrical defect in a part of the pixel out of the reference image signal components obtained from the respective pixels of the solid sensor when reference image information is recorded on the solid sensor and position information representing the position of the defective pixel from which the defective reference image signal component is obtained,
a correcting condition setting system which sets a condition of correction on the basis of which the defective reference image signal is corrected to be substantially equal to a normal reference image signal component obtained from a normal pixel when the reference image information is recorded on the solid sensor, and
a correcting information outputting system which outputs the condition of correction set by the correcting condition setting system and the position information detected by the defect detecting system.
